(19) United States
(12) Patent Application Publication
(10) Pub. No.: US 2012/0144682 A1
(43) Pub. Date: Jun. 14, 2012

(54) DEVICE FOR LOCATING A LOAD IN LIFTING PLANTS

(75) Inventors: Felice VINATI, Castegnato (Brescia) (IT); Samuele VINATI, Brescia (IT); Matteo VINATI, Castegnato (BS) (IT); Giacomo VINATI, Brescia (IT); Mariachiara VINATI, Castegnato (BS) (IT)

(73) Assignee: VINATI SERVICE DI VINATI FELICE E C. S.A.S., Castegnato (Brescia) (IT)

(21) Appl. No.: 13/316,089

(22) Filed: Dec. 9, 2011

(30) Foreign Application Priority Data
Dec. 14, 2010 (IT) MI2010A002279

(51) Int. Cl. G01B 1/00

(52) U.S. Cl. 33/263

(57) ABSTRACT

A device for locating loads destined to be applied to a cable- and/or chain- and/or hydraulic-type lifting plant, in which the plant includes a lifting system to which a gripping element for a load is connected via a cable or chain system, and is provided with projector for projecting visual indications correlated with the position or the displacements of the load.

### RELATED APPLICATION

The present application hereby claims priority under 35 U.S.C. Section 119 to Italian Patent application number MI2010A002279, filed Dec. 14, 2010, the entire contents of which are hereby incorporated by reference.

### FIELD OF INVENTION

The present invention relates to a device for locating loads in lifting plants.

### BACKGROUND

The device of the invention can be applied to cable-lifting apparatus, such as bridge cranes, construction cranes, motor winches and chain or hydraulic apparatus or like apparatus (for example lifting clamps, beams or the like) destined to lift and move loads.

As is known, bridge cranes are machines destined to lift and displace materials and goods, both in outdoor and indoor situations, and are generally constituted by a bridge crane, mobile in a horizontal direction along a pair of tracks or pathways and provided with a crossbar for a carriage on which a pulley block is mounted that can move horizontally along the crossbar and to which a pulley is connected, which pulley is provided with a hook for gripping and raising the objects.

One or more cables are applied to the pulley block, which via a system of pulleys, return pulleys and hooks enable the weights to be lifted and moved.

In the prior art, these operations are performed with the load positioned solely by sight and depending on the experience of the lifting plant operator.

In practice, the operator nears the load, after having identified it, and directs the lifting hook to which the load is to be attached in order to be raised.

During this maneuver, the operator begins by moving the bridge crane and simultaneously lowering the hook which thus serves as a reference for locating the crane with respect to the load to be lifted.

This maneuver however involves some dangers, especially where there are people present in the loading area, for example workers in a workshop; it is quite common for these workers to be instructed to take care with regard to the hook moving towards them.

Further, during the displacement, the hook oscillates absolutely unpredictably and randomly, a phenomenon which increases at it approaches the ground.

### SUMMARY

An aim of the present invention is to obviate the above-cited drawbacks, considerably increasing the degree of precision and safety in the movement of the loads of the lifting system.

A further aim of the invention is to provide a safety device that locates the load during the functioning of the lifting plant.

A further aim of the invention is to attain the result in a way which is practical and economical.

The aims are attained with a device for locating loads destined to be applied to a cable or chain or hydraulic lift plant, or a combination thereof, in which the plant includes a lift system to which is connected, via a cable or chain system, a gripping element for a load, the device being provided with a projector that projects visual indications correlated to the position or the displacements of the load.

### BRIEF DESCRIPTION OF THE DRAWINGS

Further characteristics and advantages of the invention will emerge from a reading of the following description, provided by way of non-limiting example, with the aid of the figures illustrated in the accompanying figures of the drawings, in which:

FIG. 1 illustrates a lift plant according to a first embodiment of the invention;

FIG. 2-4 illustrate different embodiments of the invention;

FIG. 5 is a further embodiment of the invention;

FIG. 6 is an embodiment applied to an underhook lifting beam;

FIG. 7 is a further embodiment of the invention.

### DETAILED DESCRIPTION OF THE PREFERRED EMBODIMENTS

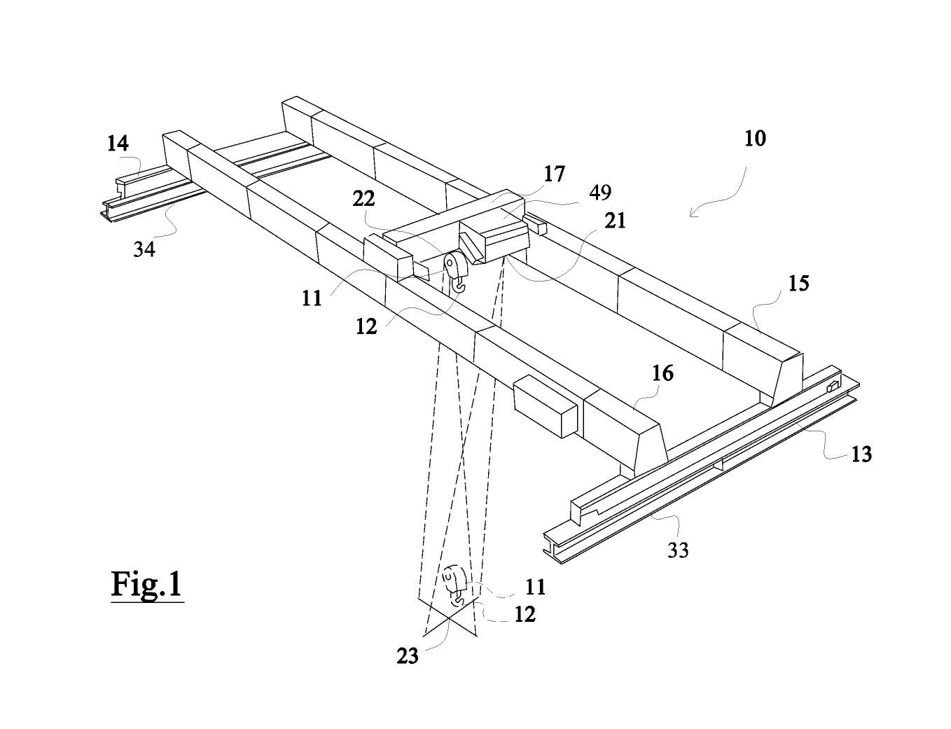

FIG. 1 illustrates a safety device for a cable lift plant of the invention, denoted in its entirety by reference number 10.

FIG. 1 shows the plant 10 in a schematic view, comprising a bridge crane provided with a pulley block 11, in turn provided with a hook 12, and destined to raise or lower a load (not illustrated for the sake of simplicity) by means of a system of cables activated by a pulley block 18 mounted on a crossbar 17 provided with a carriage 49. In turn, the crossbar 17 is mobile along two parallel uprights 15, 16, which can slide in a perpendicular direction to the movement of the crossbar 17 which is performed by displacing two heads 13, 14 along two beams 33, 34.

In the invention, the plant 10 comprises at least a light projector designed to project light indications correlated to the position of the hook 12 or to the overall dimension thereof.

In general the projectors usable can be laser or light beam projectors; in any case they will be such as to project points, lines, crosses, circles and combinations thereof or other forms, with the aim of projecting on the ground or other appropriate surface a series of light beams that are visible to the operators, and which identify the center of the hook 12.

In particular, in the case of the plant 10, the projectors 21, 22 are configured such as to project a cross 23 on the ground to identify the center of the hook 12.

In a variant, not illustrated for reasons of simplicity, the projects can be configured such as to create three lines which create a three-line pattern on the ground which the operator identifies as a hook 12 position or a loading zone.

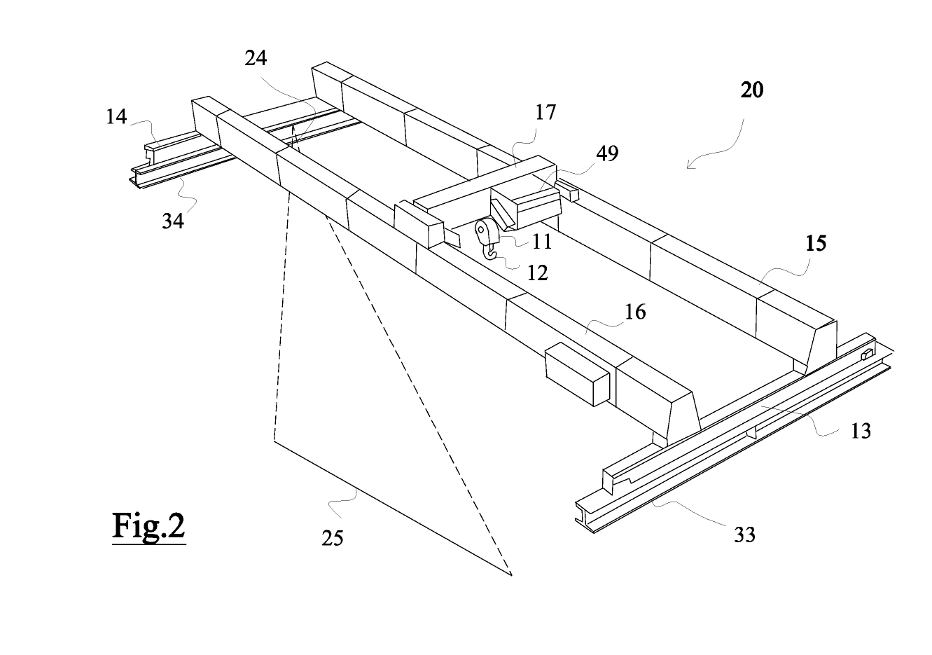

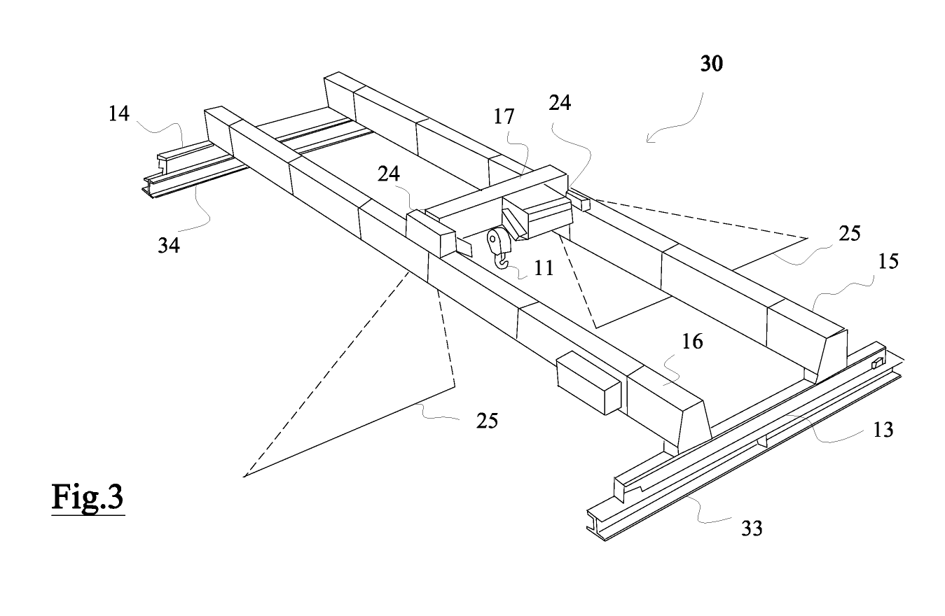

An alternative is illustrated in FIG. 2, in which a plant 20 is represented, which comprises a projector 24 which is able to project a line 25 onto the ground which identifies the median line in a longitudinal direction of the bridge crane. A second alternative is represented in FIG. 3, in which a plant 30 is illustrated, which provides projectors 24 able to project lines 25 onto the ground which identify the median line in a transversal direction of the bridge crane. The system enables the trajectory of the bridge crane to be highlighted, as a warning to personnel internally of the operating area of the crane.

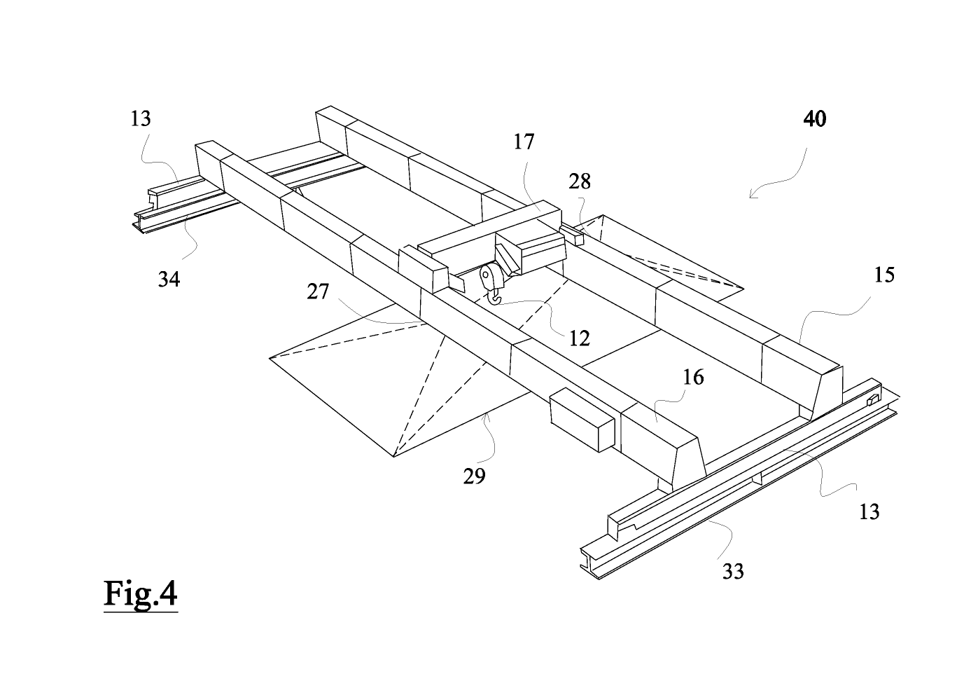

A further realization of the invention is illustrated in FIG. 4, in which a plant is illustrated 40 that comprises projectors 27, 28 able to project a series of lines on the ground, which lines identify the delimitation of an operating area 29 to be made safe, and internally of which nobody must remain or enter.

This can also occur by a combined use of a plurality of projected beams located for example on both heads 13, 14 of the bridge crane 10-40 and/or of the carriage 49.

A further example is the application of the projectors 61, 62 to an underhook bar 60 for guaranteeing its exact positioning, in a case, for example, of lifting 12-metre long iron sheet bundles performed by a 4-metre long bar.

In cases such as the above, the operator has difficultly centering the load, and wrong centering causes the problem of having an inclined and therefore dangerous load.

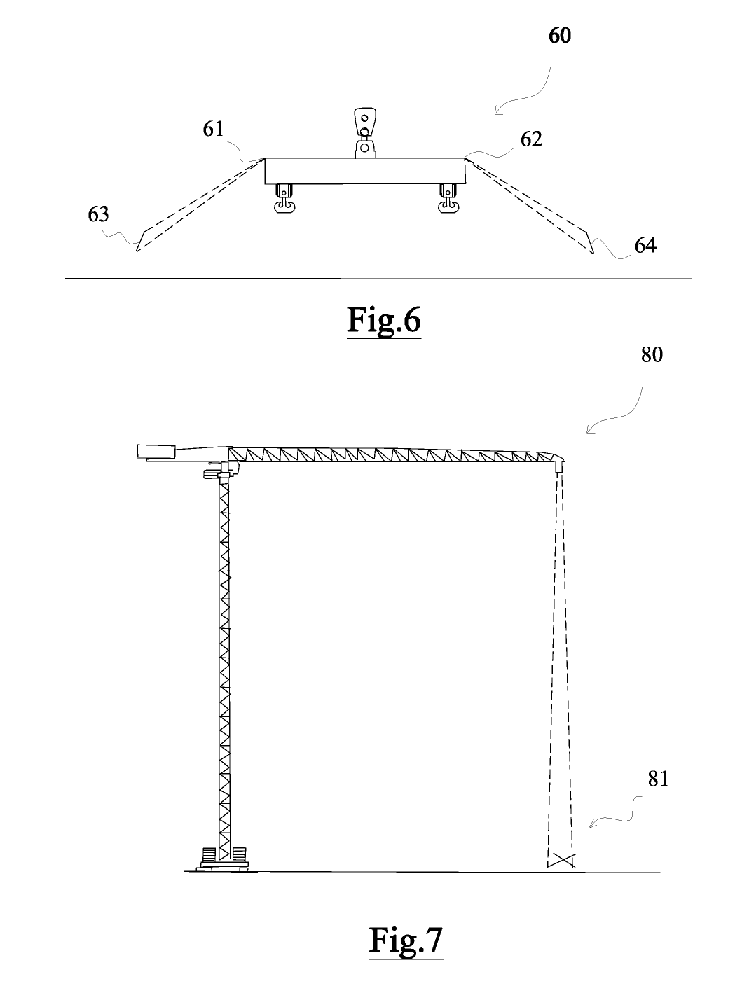

The use of two projectors 61, 62 situated at ends of the bar, which project two lines 63, 64 located at a predetermined distance (for example 12 meters) enables a precise positioning to be obtained, using the linear references thus-created (FIG. 6).

The invention can also be applied to motor cranes having a telescopic arm 70, which reach considerable heights.

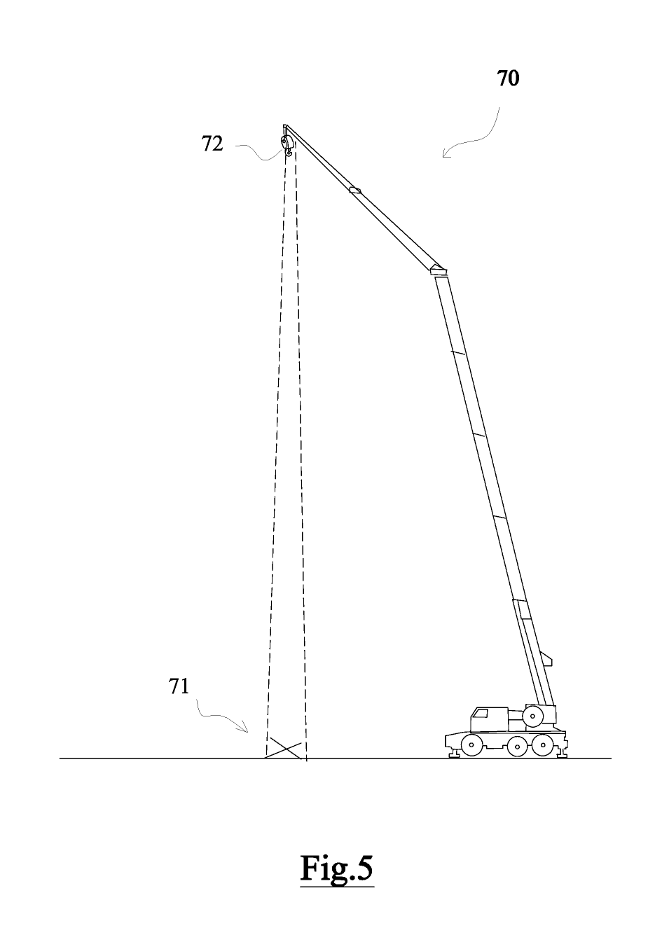

These can position the arm while controlling the position of the hook 72, for example by projecting the cross 71, and the load can then be collected (FIG. 5). In the case of construction cranes 80, which reach considerable heights, the possibility for the operator to verify the position in which the virtual hook is positioned, for example by the projection of the cross 81, enables not only an increase in the degree of safety, but also an acceleration in operating times (FIG. 7).

Another possible case of use is in positioning for special operations, such as kilns positioned on the ground or the like, in such a way that the light beam generated enables the operator more precisely to position the hook without having to approach the load; this can be left to after positioning has been done, such as to hook on the load.

The invention further enables visual verification of any attempts at oblique loading, as it is well-placed to see that the hook is not in a position corresponding to its center of gravity during a loading attempt; this constitutes a further safety application for the lifting device.

The invention is also applicable to clamps of various nature, for example for lifting coils, sheet metal or other types besides, with the aim of identifying the centering of the objects to be lifted.

If associated to the system described in patent application MI2008A000901, by the same inventor, the invention enables orientation of the light beams which follow the position of the hook.

In the above-cited document, to which reference is made for a more complete description and which is considered to be comprised as a whole in the present description, a three-axis accelerometer group is comprised and mounted such as to detect the displacements of the cable in the various spatial directions, taking account of the time and ambient temperature.

In this case, the accelerometer system enables the beams to be directed following the positional indications of the accelerometer group itself.

The present invention is provided with obvious advantages in terms of safety, namely the following.

Firstly, the operator can translate the lift device while maintaining the hook raised and thus preventing causing a danger to other persons who might inadvertently be struck by the moving and swinging hook of the crane or bridge crane. Further, the hook located at the top of the bridge crane or the other lift device reduces its swinging.

The invention enables fine precision in the positioning of the bridge crane or the other lift device for hooking on the load.

With the use of remote commands instead of a command button panel, the operator can see the exact position of the virtual hook while remaining at a distance from the load and the bridge crane.

The invention further offers the possibility of a faster sliding of the bridge crane or other lift device in full safety conditions and without creating danger to persons present in the loading and unloading operating area, with the possibility for persons to optically see the lift device in arrival in the area. The laser pointer is lit according to the forward or rearward advancement direction.

The invention is applicable to any lift device, either already in existence or newly constructed.

The use of projectors further enables projecting complex images such as direction arrows or shapes which are adaptable to the shape of the load.

The use of positioning lasers positioned on the ground such as to form and visualize the center of the hook enables displacements of the lift device to be made with hook retained in a high position; it is only once that the visual reference of the hook is positioned on the load to be raised, and only then, that the operator can begin to lower the hook to perform the loading operation.

It can be seen that the projector that projects visual indications of the invention are configured in such a way to project visual indications that indicate the position of the hook, both in case that a load is not present on the vertical of the hook, or in case a load is present on the vertical of the hook, and in this last case the visual indication is represented on the load itself.

This effect can be obtained, for example but not exclusively, because the projecting visual indications projector is able to project cross forms, circle forms, three-lined elements or triangles or other forms.

As a consequence, independently from the distance between the visual indications projector and the surface of projection, it is always possible to visualize one or more of the above described shapes, eventually having different dimensions in one or the other case.

In general then, the visual indications can be configured in such a way to indicate the vertical of the gripping element or the loading zone independently from the distance between said visual indications projector and the surface on which said visual indication are projected. Obviously modifications or improvements can be brought to the invention, dictated by contingent or special requirements, without its forsaking the ambit of the invention as claimed herein below.

What is claimed is:

1. A device for locating loads destined to be applied to a cable-, and/or chain- and/or hydraulic- type lifting plant (10-80), in which the plant (10-80) comprises a lifting system to which a gripping element for a load is connected via a cable or chain system, the device comprising a projector that projects visual indications correlated with a position or displacements of the load, the visual indications being configured in such a way to indicate a vertical of the gripping element or a loading zone independently from a distance between said visual indications projector and a surface on which said visual indication are projected.

2. The device of claim 1, wherein the visual indications projector is a laser projector or light beam projector, configured to project light indications on a ground surface or on another suitable surface.

3. The device of claim 2, wherein the light indications identify the vertical of the gripping element (12).

4. The device of claim 2, wherein the visual indications projector is configured such as to project a cross (23) or a three-lined element on the ground surface, which identifies the vertical of the gripping element (12) or the loading zone.

5. The device of claim 2, wherein the visual indications projector (24) is configured such as to project lines (25) which identify a median line in a longitudinal direction of the bridge crane.

6. The device of claim 2, wherein the visual indications projector (24) is configured such as to project lines (25) which identify a median line in a transversal direction of the bridge crane.

7. The device of claim 2, wherein the visual indications projector (24) is configured such as to project lines which identify a delimiting of an operating area (29) of the lifting plant (10-80).

8. The device of claim 2, wherein the visual indications projector (24) is configured such as to project combinations of a plurality of light beams and is located on heads (13, 14) of the lifting plant (10-40) and/or of a carriage (49) thereof.

9. The device of claim 2, wherein the visual indications projector (61, 62) is applied on an underhook lifting beam (60) such as to guarantee exact positioning thereof by a projecting of two lines (63, 64) located at a predetermined distance at sides of the lifting beam (60).

10. The device of claim 2, wherein the visual indications projector (61, 62) is applied to lifting clamps to identify a centering of the lifting device.

11. The device of claim 2, wherein the projector of visual indications (61, 62) are associated to a three-axis accelerometer group mounted such as to detect displacements of the load in various spatial directions such as to enable the light indications to be directed following positioning indications of the accelerometer group.
